(19) United States
(12) Patent Application Publication
(10) Pub. No.: US 2005/0272892 A1
(43) Pub. Date: Dec. 8, 2005

(54) Hydrolyzates of soybeans or other soy products as components of thermosetting resins

(76) Inventors: Chung Yun Hse, Pineville, LA (US); Liangzhen Lin, Pineville, LA (US)

Correspondence Address: VENABLE LLP, P.O. BOX 34385, WASHINGTON, DC, 20045-9998, US

(21) Appl. No.: 11/091,367

(22) Filed: Mar. 29, 2005

Related U.S. Application Data
(63) Continuation of application No. 10/864,886, filed on Jun. 10, 2004, now abandoned.
(60) Provisional application No. 60/477,750, filed on Jun. 12, 2003.

(51) Int. Cl. C08H 1/06

(52) U.S. Cl. 527/100

(57) ABSTRACT

This invention relates to an economically effective chemical process for converting processed soy into phenol-formaldehyde-like, water resistant thermosetting resin adhesives for the structural composite panel and veneer laminating industries.

### FIELD OF THE INVENTION

The present invention generally relates to soybean-based wood adhesives, and more particularly to the use of soybeans, soy meal or soy flour to make a hydrolyzate that is then used as a major component in the manufacture of thermosetting adhesive resins for wood-based building panels.

### BACKGROUND OF THE INVENTION

Wood adhesives and resins have greatly contributed to the construction and housing industries for about a century and will continue to play an important role in this field. About 1.2 billion pounds of thermoplastic and thermosetting resins are used annually in the United States as adhesives and coatings. Applications include plywood, particleboard, flakeboard, laminated veneer products, fiberboard, furniture, and many paper products, as well as other packaging and labeling applications. Phenolic resins are the major component of this family of products, and others cannot replace their important position due to their excellent chemical and mechanical properties and relative costs. However, the increasing cost of phenol-formaldehyde (PF) adhesives has been an important concern, because they are produced from petrochemicals, such as phenol and formaldehyde.

Recently many efforts have been made to find new alternative sources for the replacement of petroleum-based chemicals for adhesives. It has been proposed that plant resources are among the possible substitutes. Furthermore, owing to improvements in agricultural productivity and increased competition from abroad, prices of agricultural products such as corn, soybeans etc. have considerably decreased to the detriment of soybean farmers, for example. As a consequence, government and the soybean industry are cooperating in encouraging research programs directed toward finding higher-value, non-food uses for commodity soy products and other biomass materials. Adhesives made from soybeans which would meet the modern requirements of wood-based structural panels for construction and furniture would not only benefit soybean farmers, they would decrease dependency on adhesives made from petroleum-based chemicals. Phenol, for example, the main component of most of the adhesives made for the structural wood-based panel industries, is a petroleum-based derivative and its price fluctuates greatly and steadily increases over time.

The use of biomass materials for adhesives has long been of interest to phenolic resin manufacturers whenever the price of phenol threatens to raise the price of resin adhesives. For example, U.S. Pat. No.3,223,667 describes a resin composition comprising an alkali-bark derivative and a polymethylol phenolic compound which can be condensed into a phenolic resin and will also condense with the alkali-bark derivative. U.S. Pat. No. 3,025,250 relates to phenolic resins that are further reacted with alkali-bark derivatives obtained by treating suitable bark at a temperature of from about 90 to 170 degrees Celsius with an aqueous alkaline solution. U.S. Pat. No. 3,017,303 relates to extenders for phenolic resin adhesives, which are naturally occurring lingo-cellulose and alkali lignin. U.S. Pat. No.3,008,907 relates to an extender for phenolic resins that is an alkali metal reaction product of a conjointly cooked alkaline mixture of the cereal flour and vegetable material such as ligno-cellulose. The disclosed cereal flour is wheat flour. The disclosed ligno-cellulose materials are tree bark, nutshells, and the endocarps of drupes. U.S. Pat. No. 4,201,700 relates to phenol-aldehyde resin composition containing the condensation product of an alkali organic extract of peanut hulls and pecan piths polymerized with an aldehyde.

Protein is one of the most abundant natural polymers. Its special molecular structures provide many possibilities for making protein-based adhesives. However, its serious inter- and intramolecular interactions, such as hydrogen bonding, steric repulsions, van der Waals attractions, and solvation, contribute to the coiled molecules and three-dimensional conformation of proteins. These greatly hinder its reactive functional groups from chemical reaction and inhibit its solubility and hence increase the difficulties of its use as adhesives to some extent. Therefore, in making protein-based adhesives it is necessary to disperse and unfold the protein molecules in solution. Soybean protein, like other proteins, has a complex three-dimensional structure that is dependent on hydrogen bonding and disulfide cross-linking between the individual amino acid side groups.

The utilization of soybeans for wood adhesive dates from the 1920s when Johnson, Davidson and Laucks developed a soybean-based plywood adhesive. The soybean adhesive-based softwood plywood industry grew steadily over the years until about 1950, during which none of the plywood produced was used for building construction as exterior panels or sheathing. The annual consumption of soybean flour in wood adhesives reached a peak in the 1960's. Since then, the soybean-based adhesive industry underwent a long-term decline due to the impact of petrochemical-based synthetic adhesives and the growing demand for all-weather (waterproof) plywood.

In most cases, making improved soybean-based wood adhesives involves hydrolysis of soybean protein as the first step for breaking down its folded structures in order to expose functional groups and increase its water solubility. In the second step, the soybean protein hydrolyzate is used to replace a portion of phenol-resorcinol-formaldehyde (PRF) or phenol formaldehyde (PF) resin by mechanical mixing. Therefore, the hydrolysis conditions are the important parameters that greatly affect the properties of the final soybean-based adhesives (Vijayendran, 1998; Clay, 1999; Conner, 1989; Kuo, 2000; U.S. Pat. No. 6,306,997, Kuo et al., U.S. Pat. No. 6,518,387, Kuo et al. and US 2002/0153112, Vijayendran et al.). These references prepare the hydrolyzate and resin in different fashions, e.g., the hydrolyzate is combined with a pre-made resin, which may comprise phenol-formaldehyde.

The hydrolysis of protein is the key step for making protein-based adhesives. It is essential to control the molecular weight and its distribution, amine functionality, and viscosity of the hydrolyzate. These parameters greatly affect the cross-linking reaction with PRF or PF resins as well as the mechanical and physical properties of the end products. Although many efforts have been undertaken to develop water-resistant protein-based adhesives, this traditional method still has the following problems to overcome: 1) the hydrolysis process is time-consuming; 2) incorporation of soybean hydrolyzate into PF resin apparently is just through mechanical mixing; 3) the viscosity of the resultant adhesive is rather high for practical application; 4) the reported curing rate of the protein-based adhesive is substantially slower than commercial resins; 5) panels made from such adhesive do not appear to have a high degree of water resistance unlike those with conventional petroleum-based PF resins.

The present invention solves these and other problems by providing an improved process for the production of soybean-based thermosetting resins. This process converts the soy product hydrolyzate, e.g. soy flour or soy meal, into a phenol-formaldehyde adhesive, wherein the soy component is substituted for about 10% to about 75% of the total phenol in the resin. The resultant resins have properties comparable to—or better than—adhesives for commercial PF use in structural, exterior wood-based panels. The process includes two steps: a) the preparation of a hydrolyzate in the presence of water and a phenol with a strong alkali and optionally a strong acid; and b) subsequent co-polymerization of the hydrolyzate with additional phenol and aldehyde.

### SUMMARY OF THE INVENTION

The present invention relates to a soybean-based hydrolysis process in which the presence of a phenol activates the protein and carbohydrate components of soybeans, soy meal or soy flour such that hydrolyzates can be formed at elevated temperatures in remarkably short time periods. Hydrolyzates are stable and can be stored under ambient conditions for long periods and can be produced at a third party facility at or near the source of soy product producers to take advantage of the very low cost of these products in large bulk quantities. Whether produced independently or directly by a resin company, such hydrolyzates subsequently are reacted with a formaldehyde, additional phenols if necessary, an alkali and other proprietary ingredients to prepare thermosetting resin adhesives specifically designed for use in by producers of flakeboards such as oriented strandboard (OSB), plywood and other laminated veneer products. The final resin adhesive is economically attractive, with the soy component in the hydrolyzate replacing at least about 10% of the total phenol component of the thermosetting resin produced by reacting the hydrolyzate with the other resin-forming ingredients.

According to the invention, a soybean product such as beans, meal, or flour, is first mixed in the presence of water, a phenol and a strong alkali, optionally with a strong acid at elevated temperature to form a hydrolyzate. The extent of the hydrolysis and the properties of the resulting hydrolyzate can be easily and effectively controlled to a desirable level by adjusting: the particle size of the soybean product, the phenol/water ratio, the amount of alkali used, the order of addition of the alkali and acid, if used, during the hydrolysis reaction, and the reaction time and temperature.

The hydrolyzate is then reacted with the additional components of the thermosetting resin in the same resin reactor used to prepare the hydrolyzate or a separate vessel. The hydrolyzate can be used to substitute from about 5 or 10% to about 75% or preferably from about 25 to about 50% of the phenol that would be used in conventional processes in the preparation of PF resin. Additional phenol can be added to the hydrolyzate with an aldehyde such as formaldehyde and then heated to an elevated temperature, e.g., about 50-150 degrees C., preferably about 75-120 degrees C. for at least one hour, e.g., 60-300 minutes, preferably about 100-250 minutes, to obtain low-cost soybean-based, phenol-formaldehyde, thermosetting resins. It is possible to add all of the phenol required in the final resin during preparation of the hydrolyzate so that only formaldehyde and additional alkali need be added during the second step. Adhesives made from these resins, when used to make structural wood-based composites such as flakeboards, plywood and veneer laminates, produce panels with properties comparable to those made from commercial exterior PF adhesives under identical laboratory conditions, at much lower cost, using renewable resources.

The process of the present invention provides a variety of advantages. First, the present invention provides a simple and effective method for converting soy meal or flour into a PF-like resin. The hydrolysis of soy flour can be accomplished in 10-120 minutes, depending on which of the three methods of preparation is used. The method of preparation may include: 1) the use of phenol in water and an aqueous solution of a strong alkali only; 2) the use of phenol in water and a strong alkali initially, followed by the addition of an aqueous solution of a strong acid; or 3) or a two-stage hydrolysis reaction consisting, in the first stage, of the addition of phenol and water and a minor amount of a strong acid reacted for up to 30 minutes, then followed in the second stage by the addition of a strong alkali with the reaction continuing for a period up to about an additional 30 minutes to complete the hydrolysis. Phenol is present in the hydrolysis as an additive to facilitate the direct reaction between phenol and the soybean constituents as well as to control the extent of hydrolysis and the properties of the hydrolyzate. The acid, if it is used, improves the reactivity of the functional groups of the carbohydrate fraction of the soybean to yield a hydrolyzate with lower viscosity. The preparation of the hydrolyzate and the subsequent co-polymerization can proceed in the same apparatus, but because of the great stability of the hydrolyzate, it can be made in large batches, stored and used on demand to prepare the resin. Thus, the inventive hydrolyzate has independent value in the adhesive industry. The inexpensive soy material replaces from about 10% to about 75% of the total phenol in the PF resin. Since this technique permits the whole process to be accomplished within a very short time and can use either soybeans, soy meal or soy flour, the least expensive soy products, it is very simple compared with prior methods and offers an economically feasible technique for converting soy products into durable, thermosetting adhesives.

Adhesives made by this process to produce Oriented Strandboard (OSB) have been shown to possess water resistance and bond quality as good as, or better than, commercial resins used under the same conditions.

In one exemplary embodiment, the invention relates to a water-resistant thermosetting adhesive resin comprising a phenol-activated hydrolyzate of soy and an aldehyde. The mass of soy can be from about 5% to about 75%, about 30%, about 50% or at least about 20% of the total mass of the soy and phenol. The ratio of soy to phenol can from about 1:6 to about 1:1.

An exemplary embodiment of the resin can comprise from about 5% to about 25% soy, from about 15% to about 50% phenol, and from about 10% to about 50% aldehyde. The resin can further comprise about 4% to about 25% alkali or about 0.4% to about 10.0% acid. The resin can have a solid content from about 40% to about 60%, a viscosity from about 100 cps to about 10,000 cps or a pH is from about 9 to 13.

The present invention also relates to a process for making a thermosetting adhesive resin, comprising hydrolyzing a soy product in the presence of water, a phenol, and an alkali, to form a reactive hydrolyzate, and combining the hydrolyzate with an aldehyde and producing a phenol-substituted aldehyde thermosetting adhesive resin. This process can further include combining additional components such as extenders, fillers, water and sodium hydroxide to the final resin product for possibly manufacturing laminated veneer products.

The hydrolyzing step of this process specifically include combining soy with a phenol, water, and an aqueous strong alkali, and stirring and heating the hydrolyzate mixture at about 50 to about 150 degrees Celsius for at least about 10 minutes to produce the reactive hydrolyzate. The process may further include combining aldehyde, phenol and alkali with the hydrolyzate to form a resin mixture and heating the resin mixture at about 50 to about 120 degrees Celsius for at least about 30 minutes to produce the resin. The aldehyde used in the inventive process may be formaldehyde, paraformaldehyde, trioxane, hexamethylene tetramine, glyoxal or formalin.

The soy product can be soybean, soy flour or soy meal and the resin may comprise from about 5% to about 30% of soy by weight. The phenol component maybe phenol, cresol, xylol, resorcinol and/or combinations and may be in an amount from about 15% to about 200% or from about 25% to about 50% of the weight of the soy. The alkali may be selected from the group consisting of sodium hydroxide, ammonium hydroxide, alkaline metal hydroxide, alkaline earth hydroxide and/or combinations and is in an amount from at least about 5% to about 25% alkali by weight of the soy. The alkali can be provided as a 50% aqueous solution.

The process can also include combining a strong acid with the hydrolyzate mixture, which can be added after the alkali or before the alkali. The acid can be sulfuric acid, hydrochloric acid or phosphoric acid. The acid in the hydrolyzate mixture can be in an amount from about 0.5% to about 5.0% of the combined dry weight of phenol and soy in the hydrolyzate. The invention also relates to a method of using the resin comprising combining the resin with wood particles to produce a wood product, which may include plywood, particleboard, flakeboard, a laminated veneer product, fiberboard, furniture, molded products or paper. The resin can be a liquid that is applied by spraying or can be dispersed as a powder.

The invention also relates to a wood product comprising wood particles and a water-resistant thermosetting adhesive resin comprising a phenol-activated hydrolyzate of soy and an aldehyde. In another exemplary embodiment, the invention is a process for making a hydrolyzate of soy useful for producing a thermosetting adhesive resin, comprising hydrolyzing soy in the presence of water, a phenol, and an alkali, to form a hydrolyzate.

In yet another exemplary embodiment, the invention is a phenol-activated hydrolyzate of soy comprising a soy product reacted with phenol to produce a reactive hydrolyzate. The phenol maybe in an amount from about 1% to about 250%, from about 1% to about 100%, from about 10% to about 75% or from about 15% to about 50% of the weight of soy. The hydrolyzate may also include an alkali in an amount from about 0.5% to about 25% of the weight of the soyproduct or an acid in an amount from about 0.4% to about 5% of the combined weight of phenol and the soy product. The hydrolyzate may have a solid content of about 45% to about 65%, a viscosity of about 100 to about 160,000 cps or a pH of about 9 to about 13.9.

Further objectives and advantages, as well as the structure and function of preferred embodiments will become apparent from a consideration of the description, drawings, and examples.

### DETAILED DESCRIPTION

Embodiments of the invention are discussed in detail below. While specific exemplary embodiments are discussed, it should be understood that this is done for illustration purposes only. A person skilled in the relevant art will recognize that other components and configurations can be used without departing from the spirit and scope of the invention. All references cited herein are incorporated by reference as if each had been individually incorporated. All examples presented are representative and non-limiting. It is therefore to be understood that, within the scope of the claims and their equivalents, the invention may be practiced otherwise than as specifically described.

The present invention relates to a process for converting soybean products (for example, Cenex Harvest States Oil Seed Processing and Refining, Mankato, Minn. 56001) into a thermosetting wood adhesive, that includes the preparation of an activated soy hydrolyzate and then co-polymerization of the hydrolyzate with additional phenol and formalin.

Soy-beans, -meal or -flour or other soybean products can be used to prepare the inventive hydrolyzate, but soy flour is preferred for easier handling and faster hydrolysis time. As used herein, “soy product,” “soy,” or “soybean” is generally meant to encompass all such soy products and others. An example of soybean product has the following approximate composition: crude protein about 51%, crude fat about 0.15%, crude fiber about 3.2%, moisture about 8.0%, ash about 5.8%, and carbohydrate about 34% (Wolf, et al., 1975).

The term “hydrolyzate” is used to define the product of the activation and hydrolysis reaction in which the soy products are activated by a phenol in the presence of water, an alkali and/or an acid. The hydrolyzate is advantageously aldehyde free, and is distinct from the resin formed with an aldehyde. To prepare the hydrolyzate, the soy flour may be activated by being blended with water, phenol, and at least one type of strong alkali and/or one type of strong acid to obtain a mixture. The mixture then undergoes a hydrolysis reaction by heating and stirring at about 50-150 degrees Celsius for about 10 to 120 minutes to convert the soy powder into a water-soluble liquid. After the volatile portion of the liquid has been evaporated, the hydrolyzate may have a solids content of about 45 to about 55% and a viscosity of about 1200 to about 16,000 cps.

In an exemplary embodiment, soy flour is first subjected to activation and hydrolysis in the presence of phenol, a strong alkali or a strong acid followed by a strong alkali, at temperatures from 50 to 150 degrees C. The hydrolysis reaction is usually completed within 15-120 minutes. The presence of phenol activates the soy components in the hydrolysis, inhibits gelling and over-degradation of the protein molecules, and improves the physical and mechanical properties of the final adhesive. When strong acid is used in the hydrolysis reaction the functional groups on the carbohydrate fraction of the soybean also are activated. The resultant hydrolyzate is then co-polymerized with additional phenol and formaldehyde at 50 to 150 degrees C. in a reaction time from about 70 to 300 minutes, to obtain a PF-like adhesive. Other moieties may be used alone or in combination with phenol or formaldehyde to obtain thermosetting resin adhesives. A unique feature of this process is that, on a weight basis, the soybean component can replace from about 10% to about 75% of the phenol used to make conventional phenol-formaldehyde adhesives, thus making it economically attractive both to the resin manufacturer and the panel producer. Further, the hydrolyzate can be made in the same reactor that is used to make the resin after the hydrolyzate has been cooled down. Because of the long storage life of the hydrolyzate, however, it can be made separately stored and used as required to make the resin.

According to the invention, phenols have great swelling power and act as a solvent with high chemical reactivity under suitable alkaline or acid conditions with both the protein and carbohydrate components of the soybean, meal or flour. The phenol makes it possible to control viscosity, to prevent protein re-condensation, and to enhance the reactivity of the hydrolyzate. The amount of phenol used can be in the range of from about 1% to about 275% of the weight of the soybean, meal or flour in either the final hydrolyzate product or the resin, depending on the amount of alkali used. Where a high amount of alkali is used, the hydrolysis reaction may proceed too violently; thus the amount of phenol can be adjusted accordingly.

The type of phenol used is not critical. As used herein, the term “phenol” or “a phenol” is not necessarily limited to phenol itself and may include hydroxyl-containing substances or a mixture of several substances that will react with the functional groups of the soybean, meal or flour and can later be reacted with resin components. Examples of phenols that may be used include phenol, cresol, xylol, resorcinol, bisphenols and biphenols. All of these compounds have reactive —OH groups and some contain —CH₃ groups. Their location on the benzene ring influences their chemical characteristics.

The strong alkali used is not critical but sodium-containing alkalis are preferred. A mixture of alkalis can be used, and the amount of alkali is preferably in the range from about 1%-100% or preferably from about 5% to about 80% by weight, based on the weight of the soy meal or flour. Calcium hydroxide and potassium hydroxide may also be used.

The purpose of adding a large amount of alkali is to speed up the hydrolysis reaction to yield a desirable viscosity and molecular reactivity. However, it can also allow the hydrolysis reaction to proceed too quickly and result in re-condensation of the protein to adversely affect the viscosity of the hydrolyzate. The presence of a phenol can interfere with the further hydrolysis of the reactive sites of the protein. Thus, controlling the alkali, phenol and temperature to the desired levels is important. Another function of the phenol is to complex with the soy protein and the carbohydrate in order to enhance the cross-linking reaction between the components of the soybean. When the soy fraction of the hydrolyzate is later used as a substitute for a significant amount of phenol in the preparation of a phenol-substituted aldehyde adhesive resin, a rapid-curing adhesive system results. In accordance with the method of this invention, the hydrolysis of the soybean products can be completed in a very short time and the components of the resulting hydrolyzate are suitable for reacting with the other components of the thermosetting resins.

Acid may be used in the preparation of the hydrolyzate. The amount of acid used may be from about 0.5% to about 10% of the combined dry weight of phenol and soy flour in the preparation of the hydrolyzate. The acid may be added before or after the alkali. Acids may be used to swell the components of the soy flour and to lower the viscosity of the hydrolyzate. The type of strong acid used is not critical but sulfuric acid is preferred. Examples of acids that may be used include sulfuric acid, hydrochloric acid and phosphoric acid. Benzene sulfonic acid and toluene sulfonic acid may also be used in the preparation of the hydrolyzate, and both phenol and cresol exhibit acidic characteristics as well.

Any vessel, apparatus, and other equipment suitable for this hydrolysis reaction process can be adapted. However, mechanical stirring is generally necessary to maintain uniform reaction conditions. In the case where the hydrolysis temperature is higher than about 100 degrees Celsius, it is preferable to use a closed-type autoclave reactor to minimize the evaporation of water or the substances with low boiling points. After the hydrolysis reaction is completed, the hydrolyzate is allowed to cool to a convenient temperature below boiling to be ready for the next step.

To prepare the resin from the hydrolyzate in the second step of this invention the soybean hydrolyzate is mixed with additional phenol and aldehyde and then subjected to heat of about 50-150 degrees Celsius for about 70-300 minutes to complete the condensation reaction. This is similar to the preparation of conventional phenolic resins. The pH of the co-polymerization reaction is adjusted in the range of about 9.0-13.9 by adding further amounts of alkali.

The amount of aldehyde may be in the range of at least about 1 to about 3 times the molar ratio of the combined phenol and soy flour (the molar weight of soy flour is assumed to be equal to that of the phenol) depending on the end-use requirements of the resin. Examples of an aldehyde include formaldehyde, paraformaldehyde, trioxane, hexamethylene tetramine, glyoxal and formalin. The co-polymerization reaction can take place in the same apparatus used in the first step, such as a typical resin reactor.

The soybean-based phenol-substituted adhesive resin prepared from the hydrolyzate may be used for making structural wood-based panels. Adhesives used to make plywood are either applied as liquid, spray or foam. In the manufacture of fiberboard, particleboard, and flakeboard (such as Oriented Strandboard), the resin is normally applied to the wood particles by spraying or by use of a spinning disk, although it also may be dispersed as a powder. Preferably the soy flour-based adhesive resin is applied in liquid form. The soy flour-based resin-coated wood furnish is deposited carefully into a forming box in the laboratory to form a uniform mat. The formed mat is consolidated in a hot press to a pre-determined thickness with sufficient pressure application to permit closing the press in about 10 to 50 seconds. The hot press temperature and time used are sufficient to cure the adhesive in the panel.

In the laboratory evaluation of the resin used to make plywood and veneer laminates, typically the resin is converted into a workable adhesive by mixing it with water and an extender such as GLU-X wheat flour (The Robertson Co. Brownstown, Ind.), Phenofil (a furfural derivative which is a product of Lufkin Pecan Co., Lufkin, Tex.), and soda ash or aqueous sodium hydroxide. The mixed glue is applied to the veneer surfaces by means of a roller spreader at the rate of about 80 to 90 pounds per about 1000 square feet of double glue line (lb./MDGL). The moisture content of the veneer is approximately about 4 to 6%. After spreading, all panel lay-ups are stored in room temperature for assembly time periods of about 5 to 30 minutes. The 3-ply panel assemblies (lay-ups) are then hot pressed, using a platen temperature of about 150 degrees Celsius and unit pressures in the order of 12 kg/cm². Immediately upon removal from the hot press, the panels are stored in an insulated but unheated box overnight to stimulate hot stacking. Because of the lower cost of the resins, the amount of extender can be decreased or eliminated entirely to increase the resin solids and improve bond quality.

The masses and weights and percents recited here for the components of the hydrolyzate and resin refer, as would be understood by a person of ordinary skill, to the weights of the starting materials added to form the hydrolyzate and the resin. During the two reaction steps, according to the invention, the character of the starting materials changes substantially, but it is appropriate and convenient to use the mass and percentage figures in this manner.

The amount of soy component used is based on the total combined mass of the soy and phenol component in either the hydrolyzate or final adhesive resin. For example, the amount of soy used in the resin can be from at least about 5%, at least about 6%, at least about 10%, at least about 20%, from about 5% to about 75%, from about 5% to about 25%, from about 5% to about 30%, from about 6% to about 10%, from about 10% to about 75%, from about 20% to about 50%, from about 25% to about 50%, up to about 50%, up to about 75%, or about 20%, about 30%, about 40% or about 50% of the total combined weight of the soy and phenol used in the final resin product. Alternatively, the amount of soy used in the hydrolyzate can be from at least about 5%, at least about 6%, at least about 10%, at least about 20%, from about 5% to about 75%, from about 5% to about 25%, from about 5% to about 30%, from about 6% to about 10%, from about 10% to about 75%, from about 20% to about 50%, from about 25% to about 50%, up to about 50%, up to about 75%, or about 20%, about 30%, about 40% or about 50% of the total combined weight of the soy and phenol used in either the hydrolyzate or in the final resin product.

The amount of phenol component is dependent on the amount of soy component used in the hydrolysis step, co-polymerization step or final resin. For example, the amount ofphenol used for the resin can be from about 1% to about 300%, from about 1% to about 275%, from about 1% to about 250%, from about 1% to about 100%, from about 50% to 300%, from about 15% to about 200%, from about 15% to about 50%, from about 25% to about 50%, from about 5% to 75%, from about 10% to 75% and from about 15% to about 25% or in a ratio of from about 1:6 to about 1:1, or about 1:6, 1:5, 1:4, 1:3, 1:2 or 1:1 to that of the soy component in the final resin. Alternatively, the amount of phenol used for the hydrolyzate can be from about 1% to about 300%, from about 1% to about 275%, from about 1% to about 250%, from about 1% to about 100%, from about 50% to 300%, from about 15 to about 200%, from about 15 to about 50%, from about 25% to about 50%, from about 5% to 75%, from about 10% to 75% and from about 15% to about 25% or in a ratio of from about 1:6 to about 1:1, or about 1:6, 1:5, 1:4, 1:3, 1:2 or 1:1 to that of the soy component in either they hydrolyzate or the final resin.

The aldehyde amounts used can be from about 10% to 50%, can be from about 10% to 40%, can be from about 10% to 30%, can be from about 10% to 20%, or about 1 to 3, about 1 to 2.3: about 1.7 to 2.2, or about 1.5 to 2.0 times the molar ratio of the combined soy and phenol content.

The amount of alkali component is dependent on the amount of soy component used in the hydrolysis step, co-polymerization step or final resin. For example, the alkali content used for the resin can be from about 0.5% to 100%, from about 0.5% to about 25%, from about 5% to about 50%, from about 5% to about 25%, from about 5% to 8%, from about 4% to 50% or from about 4% to 12% of the soy component of the resin. Alternatively, the alkali content used for the hydrolyzate can be from about 0.5% to 100%, from about 0.5% to about 25%, from about 5% to about 50%, from about 5% to about 25%, from about 5% to 8%, from about 4% to 50% or from about 4% to 12% of the soy component in either the hydrolyzate or of the resin.

The amount of acid component is dependent on the combined weight of phenol and soy components used in the hydrolysis step, co-polymerization step or final resin. For example, the acid content for the resin can be from about 0.4% to 10.0%, from about 0.4% to about 5.0%, from about 0.5% to about 10.0%, or from about 0.5% to about 5.0% of the combined weight of phenol and soy components. Alternatively, the acid content for the hydrolyzate can be from about 0.4% to 10.0%, from about 0.4% to about 5.0%, from about 0.5% to about 10.0%, or from about 0.5% to about 5.0% of the combined weight of phenol and soy components in either the hydrolyzate or the resin.

For the hydrolysis step, temperature ranges can from about 50 to about 150 degrees Celsius for at least about 10 minutes, at least about 15 minutes, from about 10 minutes to about 120 minutes or from about 15 minutes to about 120 minutes. For the co-polymerization step, temperature ranges can be from about 50 to 150 degrees Celsius, for at least about 30 minutes, for at least about 75 minutes, from about 75 to about 120 minutes or from about 80 to about 120 degrees Celsius, from about 75 to about 300 minutes or from about 100 to about 250 minutes.

The solid content of the resin can be from about 40% to about 60% and the solid content of the hydrolyzate may be from about 45% to 65%. The viscosity of the resin can be from about 100 to about 10,000, from about 200 to about 400 cps, or about 260, 280 or 390 cps. The pH for the resin can be from about 9 to 14, 9 to 13.9 or 9 to 13. The viscosity for the hydrolyzate can from about 100 to about 160,000, from about 1200 to about 16,000 cps, from about 1300 to about 9000, from about 1600 to about 7000, from about 2000 to about 4000 or from about 2000 to 3000. The pH for the hydrolyzate can be from about 9 to 14, 9 to 13.9 or 9 to 13.

The following examples are merely illustrative and not intended to be construed as limiting application of the present method.

### EXAMPLE 1

### Alkaline Hydrolysis of Soy Flour in the Presence of Phenol

308 g (calculated as bone dry) of soy flour was charged into a Parr Stirred Reactor. Then the premixed solvent consisting of 50 g 90% phenol, 400 g water, and 240 g 50% sodium hydroxide was added with continual stirring. The reactor temperature was maintained at 120 degrees Celsius and reaction time was 45 minutes. (The percentages of material components were: 5% phenol, 31% soy flour, 40% water, and 24% sodium hydroxide.) The hydrolysis resulted in a viscous but smooth and homogeneous solution.

### EXAMPLES 2-5

Using Example 1 as reference base (e.g. 5% phenol and 24% sodium hydroxide), additional soy flour hydrolyses were conducted, varying the alkaline concentration at 4 levels on a weight basis, from the 24% of Example 1, to 20% (Example 2),16% (Example 3),12% (Example 4), and 9% (Example 5). The phenol and water percentage were held constant at 5% and 40% respectively. The weight proportions of materials charged into the reactor for the hydrolyzates are summarized in Table 1.

TABLE 1
Percentage of Ingredients in Soy Flour Hydrolysis with 5% Phenol

| Example | Percentage of the hydrolysis material on a weight basis | | | |
|---|---|---|---|---|
| Number | 90% Phenol | Soy flour | Water | 50% Sodium hydroxide |
| 1 | 5 | 31 | 40 | 24 |
| 2 | 5 | 35 | 40 | 20 |
| 3 | 5 | 39 | 40 | 16 |
| 4 | 5 | 43 | 40 | 12 |
| 5 | 5 | 46 | 40 | 9 |

### EXAMPLES 6-10

### Alkaline Hydrolysis of Soy Flour without Phenol

Mainly for comparison purpose, the examples 1-5 were repeated, except that the phenol was taken out of the soy flour hydrolysis. The weight proportion of the material charged unto the reactor for hydrolyses are summarized in Table 2.

TABLE 2
Percentage of Ingredients in Soy Flour Hydrolysis without Phenol

| Example | Percentage of the hydrolysis material on a weight basis | | | |
|---|---|---|---|---|
| Number | Phenol | Soy flour | Water | 50% Sodium hydroxide |
| 6 | 0 | 34 | 40 | 26 |
| 7 | 0 | 38 | 40 | 22 |
| 8 | 0 | 43 | 40 | 17 |
| 9 | 0 | 46 | 40 | 14 |
| 10 | 0 | 50 | 40 | 10 |

After conditioning to room temperature, all hydrolyzates were evaluated for viscosity, pH, and solids content. The viscosity in the centipoises was determined using a rotational viscometer (Cole-Palmer Instrument Company, Vernon Hills, Ill.) with R-5 spindle rotating at 50 rpm. The solids content was determined by the percentage by weight of the nonvolatile matter in the in the hydrolyzate.

A comparison of the 10 soy flour hydrolyzates produced by varying alkaline contents in presence of phenol or no phenol is shown below Table 3.

TABLE 3
Effects of Alkaline Content and Phenol
on Properties of Hydrolyzates

| | | | | |
|---|---|---|---|---|
| | Alkaline | | | |
| Example No | Content (%) | Viscosity (cps) | PH | Solid content (%) |

Hydrolysis with presence of 5% phenol

| | | | | |
|---|---|---|---|---|
| 1 | 24 | 2040 | 12.2 | 55.5 |
| 2 | 20 | 2120 | 12.5 | 54.6 |
| 3 | 16 | 2220 | 13.0 | 55.1 |
| 4 | 12 | 3075 | 13.0 | 53.6 |
| 5 | 9 | 8200 | 12.7 | 54.8 |

Hydrolysis without the presence of phenol

| | | | | |
|---|---|---|---|---|
| 6 | 26 | 3105 | 12.3 | 55.9 |
| 7 | 22 | 1685 | 12.7 | 52.0 |
| 8 | 17 | 1355 | 13.1 | 55.2 |
| 9 | 14 | 2360 | 13.2 | 51.9 |
| 10 | 10 | 6950 | 12.8 | 55.7 |

With reference to Table 3, the results show that hydrolysis in the presence of phenol produced consistently higher viscosity than hydrolysis without phenol, with the exception of the high alkaline content (i.e. 26% in Example 6). These results suggest that the phenol is reacting with soy flour to produce higher viscosity. When the hydrolysis was carried out with phenol, the viscosity decreased as the alkaline content increased, with the sharpest decrease occurring when the alkaline content increased from 9 to 12%. TABLE 3 also shows that when no phenol was used to make the hydrolyzate the alkaline-viscosity relationship was U-shaped, again with a sharp drop from the low alkaline hydrolyzate (10%) and that of 14%, a low point at 17% and an increase from 17% to 26%. These results suggest that the high alkaline content causes re-condensation of the hydrolyzates which in turn results in higher viscosity. In addition, the hydrolysis of soy flour in the presence of phenol appears to not only facilitate the direct reaction of phenol with soy flour to enhance reactivity, but also to prevent the re-condensation to better control the viscosity. The difficulty in controlling low viscosity has hampered many practical applications of soy-based adhesives.

Furthermore, the results clearly show that the presence ofphenol in the preparation of the hydrolyzate provides predictable viscosity control over a wide range of alkali content. This is an important feature of this invention in that it shows that large batches of hydrolyzate can be made and stored until required to make resins designed for use as OSB or for veneer laminates. Inventive hydrolyzates prepared and stored at room temperature have maintained their initial viscosity for several weeks, unlike the limited storage life of commercial phenolic resins. This suggests the possibility that hydrolyzates could be prepared by a third party manufacturer, close to the source of the producer of soybeans, soy meal or soy flour, to be used in a different location by the resin manufacturer.

### EXAMPLES 11-16

### The Effect of Hydrolysis Temperature and Phenol on Hydrolyzate Viscosity

An additional experiment was conducted to study the affect on viscosity of three different reaction temperatures, each in the presence of 15% phenol and with no phenol. The results are shown in Table 4.

TABLE 4
Effect of Hydrolysis Temperature and
Phenol on Hydrolyzate Viscosity

| Ex- | | Percentage of the hydrolysis materials on weight basis | | | | |
|---|---|---|---|---|---|---|
| ample | Temp. | 90% | Soy | | 50% Sodium | Viscosity |
| No. | (° C.) | Phenol | flour | Water | hydroxide | (cps) |
| 11 | 80 | 15 | 43 | 37 | 5 | 8057 |
| 12 | 120 | 15 | 43 | 37 | 5 | 1987 |
| 13 | 150 | 15 | 43 | 37 | 5 | 1014 |
| 14 | 80 | 0 | 51 | 44 | 5 | 2251 |
| 15 | 120 | 0 | 51 | 44 | 5 | 1555 |
| 16 | 150 | 0 | 51 | 44 | 5 | 1577 |

With reference to Table 4, the results show that viscosity decreased as the temperature increased with exception of that made at the high hydrolysis temperature of 150 degrees Celsius without phenol. So, the presence of phenol in the hydrolysis appears to produce hydrolyzates with consistently higher viscosity except at temperatures of 150 C. The results also show that the decrease in viscosity was more consistent when phenol was used. These results suggest that higher temperatures cause re-condensation of the hydrolyzate when hydrolysis takes place without phenol.

### EXAMPLE 17

### Two-Stage Acid-Alkaline Hydrolysis of Soy Flour in the Presence of Phenol

125 g of soy flour was charged into a resin reactor equipped with a condenser and stirrer. Then a premixed solvent consisting of 308 g phenol, 452 g water, and 17 g 50% sulfuric acid was added while stirring. The first stage of the acid hydrolysis was conducted at 100° C. for 30 minutes. This yielded a smooth solution with a viscosity of about 600 cps. Then 98 g of sodium hydroxide was added to initiate the second, alkaline stage of the hydrolysis, also at 100° C. for 30 minutes. This resulted in a hydrolyzate with a viscosity of about 200 cps. The acidic hydrolysis facilitated further reaction between phenol and the carbohydrate component of the soy flour, resulting in a hydrolyzate with a higher reactivity and a much lower viscosity when compared with the alkaline-only single stage hydrolysis of Example 1.

A unique feature of this invention is that the soy component of the hydrolyzate, i.e. the soybeans, soy meal or soy flour, is used as a substitute for a portion of the total phenol present in the completed resin made from the hydrolyzate. This results in a substantially lower-cost resin without sacrificing its bonding properties. Such a resin is suitable for the manufacture of exterior structural panels. Most phenolic resins contain molar ratios of formaldehyde-to-phenol from 1.7 to 2.2. Since the molecular weight of soy flour or meal is not known, it is assumed to be the same as phenol: 94.

### EXAMPLE 18

### Preparation of a Soy-Based Adhesive Resin for use in Flakeboard

Example 1 illustrates the preparation of an alkaline-catalyzed hydrolyzate that contains 5% phenol and 31% soy flour. This hydrolyzate is used to prepare the resin described here in Example 18. The resultant resin contains a solids content of 47%. Of the solid components, 13% was soy flour, 42% phenol, 29.5% formaldehyde, and 15.4% sodium hydroxide. (The soy flour contributed from the hydrolyzate was about one third of the total amount of phenol used in the final resin.) The resin viscosity was in the range suitable for OSB manufacture.

A 5000 cc glass resin reaction kettle (manufactured by S.G.A. scientific Co., Bloomfield, N.J., USA) equipped with a thermometer, internal cooling coil, stirrer, and reflux condenser was used. To this resin reaction kettle was charged: 1135 g soy flour hydrolyzate of example 1 (having 55.5% solids), 858 g water, and 1095 g of 90% phenol with continual stirring. While maintaining the stirring throughout the condensation reaction, the temperature of the kettle was raised to 65 degrees Celsius and 1485 g of 50% formaldehyde was added in 3 equal parts at a 10-minutes interval. The temperature was then raised to 90 degrees Celsius with continual stirring until the viscosity reached 12,000 cps at 25 degrees Celsius as measured by a Cole Palmer Viscometer using a R5 spindle at 20 rpm. The temperature of the kettle was then decreased to 70 degrees Celsius and 240 g of 35% sodium hydroxide was added in 3 equal parts at 20 minutes intervals accompanying a 10 degrees Celsius decrease in temperature of the reaction kettle between each interval. A typical adhesive formula, as disclosed herein, was then prepared, and the adhesive was used in the manufacture of flakeboards in the manner described herein.

### EXAMPLE 19

### Hydrolyzate Preparation and the Resin Formulation Using the Same Reactor

In Example 18 the hydrolyzate was prepared in a Parr Stirred reactor and the resin was prepared in a 5000 cc glass resin reactor. While the Parr Stirred reactor provides operational versatility, the two-stage operation described above also has a disadvantage in a commercial production system. In this example both the hydrolyzate and the resin were prepared in the same reaction vessel as follows. To this kettle were charged: 276 g of soy flour and a premixed solution consisting of 134 g 90% phenol, 234 g water, and 416 g 50% sodium hydroxide while stirring. The kettle temperature was maintained at 100 degrees Celsius and reacted for 30 minutes. The kettle temperature was then decreased to 85 degrees Celsius. 760 g of 90% phenol and 692 g of water were added, which was followed by the addition of 1120 g of 50% formaldehyde in four equal parts at 15-minutes intervals. The temperature was then raised to 90 degrees Celsius with continual stirring until the viscosity reached 12,000 cps at 25 degrees Celsius as measured by a Cole Palmer Viscometer using a R5 spindle at 20 rpm. The temperature of the kettle was then decreased to 80 degrees Celsius and 426 g of 50% sodium hydroxide were added in 4 equal parts at 20-minute intervals accompanying a 10 degrees Celsius decrease in temperature of the reaction kettle between each interval. The final resin had a viscosity of 390 cps as measured by Cole Palmer Viscometer using R2 spindle at 20 rpm, pH 12.74, and the solids content was 46.1%.

### EXAMPLE 20

### Two-Stage Hydrolyzate Preparation and Resin Preparation

A resin was prepared using the same reactor as in Example 18 and the same apparatus as in Example 19. The hydrolyzate was prepared by charging the reactor with 220 g of soy flour and a premixed solution consisting of 590 g 90% phenol, 550 g water, and 30 g 98% sulfuric acid while stirring. The kettle temperature was maintained at 100 degrees Celsius and reacted for 30 minutes. The kettle temperature was then decreased to 80 degrees Celsius and 313 g of 90% phenol and 340 g of 50% sodium hydroxide was added slowly and reacted for 30 minutes. The reactor temperature was then decreased to 80 degrees Celsius. The resin ingredients were then added as follows: 1180 g of 50% formaldehyde were added in four equal parts at 15-minutes intervals. The temperature was then raised to 90 degrees Celsius with continual stirring until the viscosity reached 20,000 cps at 25 degrees Celsius as measured by a Cole Palmer Viscometer using a R-5 spindle at 20 rpm. The temperature of the kettle was then decreased to 70 degrees Celsius and 310 g of 50% sodium hydroxide was added in 4 equal parts at 20-minute intervals accompanying a 10-degree Celsius decrease in temperature of the reaction mass between each interval. The final resin had a viscosity of 260 cps as measured by Cole Palmer viscometer using R-2 spindle at 20 rpm, pH 12.79, and solids content 40.0%.

### EXAMPLE 21

### Preparation of High-Soy-Flour-Content Resin from Two-Step Hydrolyzate Made in the Same Reactor

A resin was prepared using the same reaction kettle as in Example 19 and with acid-alkaline hydrolysis as in Example 20. To the kettle were charged 340 g of soy flour and premixed solution consisting of 590 g 90% phenol, 550 g water, and 30 g 98% sulfuric acid while stirring. The kettle temperature was maintained at 100 degrees Celsius and reacted for 30 minutes. The kettle temperature was then decreased to 90 degrees Celsius and 340 g of 50% sodium hydroxide was added slowly and reacted for 30 minutes. The kettle temperature was then decreased to 80 degrees Celsius and 1350 g of 50% formaldehyde was added in four equal parts at a 15-minute intervals. The temperature was then raised to 90 degrees Celsius with continual stirring, until the viscosity reached 20,000 cps at 25 degrees Celsius as measured by a Cole Palmer Viscometer using a R5 spindle at 20 rpm. The temperature of the kettle was then decreased to 70 degrees Celsius and 310 g of 50% sodium hydroxide was added in 4 equal parts at 20-minute intervals accompanying a 10 degrees Celsius decrease in temperature in the reaction kettle between each interval. The final resin had a viscosity of 280 cps as measured by Cole Palmer Viscometer using R2 spindle at 20 rpm, pH 12.65, and a solids content of 40.3%.

### EXAMPLE 22

### Soy-Based Plywood Resin with Alkaline Soy Flour Hydrolyzate

A soybean-based plywood resin adhesive was prepared using the same reaction kettle as in Example 19 and in single-stage operation by combining hydrolysis and resin formulation in the same kettle. To this kettle were charged 276 g of soy flour and premixed solution consisting of 134 g 90% phenol, 234 g water, and 432 g 50% sodium hydroxide while stirring. The kettle temperature was maintained at 100 degrees Celsius and reacted for 30 minutes. The kettle temperature was then decreased to 85 degrees Celsius. A 760 g of 90% phenol and 692 g of water were added, which was followed by the addition of 1120 g of 50% formaldehyde in four equal parts at a 15-minutes interval. The temperature was then raised to 90 degrees Celsius, with continual stirring until the viscosity reached 20,000 cps at 25 degrees Celsius as measured by a Cole Palmer Viscometer using a R5 spindle at 20 rpm. The temperature of the kettle was then decreased to 80 degrees Celsius and 360 g of 50% sodium hydroxide was added in 4 equal parts at 20-minute intervals accompanying a 10 degrees Celsius decrease in temperature of the reaction kettle between each interval. The final resin had a viscosity of 1630 cps as measured by Cole Palmer Viscometer using R2 spindle at 20 rpm, pH 12.26, and solid content 44.4%.

### EXAMPLE 23

### Soy-Based Plywood Resin with Acid-Alkaline Soy Flour Hydrolyzate

A resin was prepared using the same reaction kettle as in Example 19 and the two-step Acid-alkaline hydrolysis operation as in Example 20. To the kettle were charged 220 g of soy flour and premixed solution consisting of 590 g 90% phenol, 550 g water, and 30 g 98% sulfuric acid while stirring. The kettle temperature was maintained at 100 degrees Celsius and reacted for 30 minutes. The kettle temperature was then decreased to 90 degrees Celsius and 340 g of 50% sodium hydroxide was added slowly and reacted for 30 minutes. The kettle temperature was then decreased to 80 degrees Celsius and 1180 g of 50% formaldehyde was added in four equal parts at a 15-minute intervals. The temperature was then raised to 90 degrees Celsius with continual stirring, until the viscosity reached 20,000 cps at 25 degrees Celsius as measured by a Cole Palmer Viscometer using a R5 spindle at 20 rpm. The temperature of the kettle was then decreased to 70 degrees Celsius and 310 g of 50% sodium hydroxide was added in 4 equal parts at 20-minute intervals accompanied by a 10 degrees Celsius decrease in temperature of the reaction kettle between each interval. The final resin has viscosity 2990 cps as measured by Cole Palmer Viscometer using R2 spindle at 20 rpm, pH 12.79, and solid content 40.0%.

### EXAMPLE 24

### Fabrication of Flakeboard

The flakeboards in Examples 18, 19, 20 and 21 were made using the inventive hydrolyzate. For comparison, the following example uses a commercially available 100% phenol-formaldehyde resin having a solids content of 60%, a pH of 11.6, and a viscosity of 300 cps measured on a Cole Palmer Viscometer using spindle R2 at 20 rpm (Comparative Example C-1), which was obtained from a local flakeboard plant (Martin Lumber Co, Alexandria, La.)

To prepare each panel, the mixed hardwood flakes were weighed to make a target density of 43.7 pounds per cubic foot (PCF) and placed in a rotating drum-type blender. Likewise, an exact amount of pine flakes was weighed to produce a target board density of 42.7 PCF and placed in a rotating drum-type blender. The resin was blended in amounts equal to 4 % of the oven-dry weight of flakes. Using air-atomizing nozzles the resin was sprayed on the flakes. The average moisture content of the flakes after spraying was 11%. After blending, the randomly oriented flakes were carefully felted into a 36- by 36-inch box to form the mat. The mat was transferred immediately to a 40- by 40-inch single-opening hot press with the platen temperature regulated at 180 degrees Celsius. Sufficient pressure (about 550 psi) was applied so that the platens closed to 0.5-inch stops in approximately 25 seconds. Press times were 3- and 4-minutes after closure. All panels were hot stacked in a closed wooden box overnight immediately after removing them from the hot press.

### EXAMPLE 25

### Evaluation of Flakeboards

After conditioning in an environment of 24 degrees C. and 65% relative humidity for one week, flakeboards were trimmed to 22- by 22-inch, followed by a determination of the density of each board. Modulus of rupture (MOR), modulus of elasticity (MOE), and tensile strength perpendicular to the face, internal bond (IB) were determined according to procedures specified in ASTM Standard D1037-98 (American Society for Testing and Materials, Standard Methods for Evaluating the Properties of Wood-Based Fiber and Particle Panel Materials). For durability evaluations, an oven-dry to vacuum-pressure soak test (ODVPS) was employed with the following constraints: 1) dried at 100 degrees Celsius for 24 hours, 2) placed in a pressure cylinder and flooded with tap water, 3) vacuumed in 27±2 inch of mercury for 1 hour, and 4) put under 90±10 psi for 2 hours. The procedure was developed by the APA Engineered Wood Association and designed as APA Test Method P-1 for linear expansion (LE) evaluation. Linear expansion and thickness swell (TS) values are based on the change from the oven dry to the end of the ODVPS cycle.

A comparison of the eight resins, including the soybean-based adhesive resins of the present invention, as binders of flakes to form flakeboards is shown below in Table 5.

TABLE 5
Strength properties and dimensional stability of flakeboards
made with the soybean-based resins and the commercial resin.

| | | | | | | MOE | | |
|---|---|---|---|---|---|---|---|---|
| Example | S/P⁽¹⁾ | Cure | Panel | IB | MOR | ×100 | | |
| No. | Ratio | Time | Density | Psi | Psi | psi | LE | TS |
| 18 | 0.304 | 3 | 47.9 | 106 | 4200 | 549 | 0.59 | 34.4 |
| | | 4 | 47.0 | 110 | 4350 | 569 | 0.58 | 33.7 |
| 19 | 0.309 | 3 | 45.0 | 107 | 4715 | 560 | 0.59 | 30.5 |
| | | 4 | 45.2 | 121 | 4652 | 540 | 0.62 | 30.7 |
| 20 | 0.372 | 3 | 44.9 | 104 | 4490 | 456 | 0.52 | 31.2 |
| | | 4 | 45.5 | 107 | 4533 | 539 | 0.49 | 30.7 |
| 21 | 0.576 | 3 | 46.2 | 80 | 4760 | 581 | 0.55 | 34.0 |
| | | 4 | 45.5 | 82 | 4623 | 548 | 0.52 | 32.7 |
| C-1 | | 3 | 44.6 | 99 | 4595 | 537 | 0.58 | 30.5 |
| | | 4 | 44.4 | 117 | 4610 | 559 | 0.56 | 29.6 |

⁽¹⁾S is weight of soy flour; P is weight of phenol.

The data in Table 5 should be viewed by comparison with the resin of Example C-1, which is a commercial resin used as the control. The results indicate that the IB of all soybean-based resins at 30% substitution of phenol by soy flour (Example 18 and 19) yielded highly comparable IB strengths compared with that of commercial resin (C-1). It is noted that with the two-step acid-alkaline hydrolysis reaction in the presence of phenol (Example 20), no significant difference in IB strength was shown at 36% substitution of phenol by soy flour. Although the IB strengths were substantially lower, the resin of Example 21 is particularly interesting because it had a greater than 50% substitution of phenol by soy flour. It should be noted, however, that the average IB of slightly over 80 psi is still a respectable IB strength. It is significantly higher than the 65 psi minimum called for by U.S. Commercial Standard CS 236-66.

As with the IB strength, the durability of soybean-based resins (Example 19 and 20) is also highly comparable with that of commercial resins. However, the resins of Example 18 and 21 yielded slightly higher thickness swelling as compared with that of the commercial resin. All soybean-based resins in this invention were synthesized with at least 30% substitution of phenol with soy flour. Considering the renewable aspects of the soy flour as a substitute for phenol and the low cost of soy flour (e.g., $0.14/lb) as compared to phenol (e.g., $0.35 to $0.40/lb), the most expensive constituent of conventional PF resin adhesives, economic gains by using the soybean-based resin system could be substantial. With a 56% phenol substitution with soy flour, a soybean-based resin system as develop in this invention could result in more than a 35% saving in material cost as compared to a conventional 2/1 ratio (F/P) phenolic resin system used for bonding structural flakeboards.

### EXAMPLE 26

### Fabrication of Plywood

The plywood fabricated in Examples 22 and 23 uses the inventive resins. For comparison, this example uses a commercially available 100% phenol-formaldehyde resin in the same manner as the examples of this invention. The resin had a solids content of 60%, a pH of 12.5, and a viscosity of 1200 cps as measured by a Cole Palmer viscometer using R spindle at 20 rpm (Comparative Example C-2).

All veneers were obtained from mill-run southern pine bolts peeled at a plywood plant at Chopin, La. The ⅛-inch veneer was dried for 10½ minutes in a six-section jet dryer at temperatures ranging from 340 to 380 degrees Fahrenheit. Final moisture content averaged less than 4%. The veneers were sawn to yield 20- by 20-inch clear pieces. These pieces were randomly chosen for gluing into 3-ply panels.

Furafil and wheat flour were added to all resins to achieve 27.8% resin solids in the final mix. Ingredients of the glue mixes are shown in Table 6.

TABLE 6
Ingredients of Glue Mixes

| Ingredient | Proportion by Weight |
|---|---|
| Water (tap water as received) | 33.3 |
| GLU-X Wheat flour | 5.7 |
| Regular grind Phenofil | 9.1 |
| Mix 3 minutes | |
| Resin to be tested | 20.3 |
| Mix 5 minutes | |
| 50% NaOH solution | 3.1 |
| Mix 20 minutes | |
| Resin to be tested | 28.5 |
| Add slowly for smooth, lump-free mix | |
| Total ingredient | 100.0 |
| Total resin solid in mix | 27.8 |

Glue was spread at 85 pounds per 1000 square feet of double glueline and the veneers were immediately assembled into three-ply panels. All panels were given 10-, 20-, and 30-minutes of closed assembly times. They were then pressed for 4.5 minutes at a temperature of 275 degrees Fahrenheit and a specific pressure of 175 psi. As the panels were removed, they were placed in a hot-stack box where they remained overnight.

### EXAMPLE 27

### Evaluation of Plywood

Glue bond quality of the plywood panels was evaluated in accordance with the vacuum-pressure shear method, as described in U.S. Department of Commerce Standard PSI-74. Upon completion of the hot stacking period, the panels were trimmed to 12¼- by 12¼-inch and then cut into three 3¼-inch wide strips, as measured along the face grain axis. The center strip was held in reserve and the two outside strips were cut to yield ten standard, 1-inch-wide plywood shear specimens. The saw kerfs were balanced with regard to the effective opening and closing of lathe checks during the tensile shear test. A total of 12 specimens from each panel, six selected at ransom from each strip group of ten, were tested according to the vacuum-pressure procedure for exterior glue lines, as outlined in the standard. The percentage of wood failure and shear strength, as shown in the Table 7, each represent the average of 24 specimens, 12 taken from each of two duplicate panels.

TABLE 7
Shear strength and wood Failure of the Plywood made with soybean-based
resins and the commercial phenol formaldehyde resin.

| | Assembly Time | Shear Strength | Wood Failure |
|---|---|---|---|
| Example No. | (min.) | (psi) | (%) |
| 22 | 10 | 277 | 90 |
| | 20 | 265 | 85 |
| | 30 | 239 | 74 |
| 23 | 10 | 241 | 68 |
| | 20 | 254 | 79 |
| | 30 | 193 | 80 |
| C-2 | 10 | 303 | 86 |
| | 20 | 310 | 91 |
| | 30 | 293 | 89 |

The data in Table 7 should be viewed by comparison with the resins of Example C-2, which is a commercial resin used as the control. The results indicate that soybean-based plywood resin with alkaline soy flour hydrolyzate (Example 22) yielded highly comparable plywood shear strength and wood failure compared with that of commercial resin (C-2). Although, the plywood shear strength and wood failure were slightly lower with soybean-based resin with acid-alkaline soy flour hydrolyzate compared with that of commercial resin (C-2), it is slightly tolerable to long assembly time as compared to that of alkaline hydrolyzate (Example 22). Tolerance to longer assembly times is often considered an important resin property, particularly for bonding species such as southern pine, which is known for its property of high water absorbance.

### REFERENCES

The following patents and publications are incorporated herein by reference:
1. U.S. Pat. No. 5,371,194
2. U.S. Pat. No. 3,223,667
3. U.S. Pat. No. 3,025,250
4. U.S. Pat. No. 3,017,303
5. U.S. Pat. No. 3,008,907
6. U.S. Pat. No. 4,201,700
7. U.S. Pat. No. 6,306,997, Kuo et al.
8. U.S. Pat. No. 6,518,387, Kuo et al.
9. US 2002/0153112, Vijayendran et al.
10. Burnett. R. S. 1951. Soybean protein industrial products. In: K. S. Markley, ed. Soybeans and soybean products. Vol. II. new York: Interscience Publishers or John Wiley & Sons. P 1003-54.
11. Clay, J., et al., 1999. Rheological study of soy protein-based PRF wood adhesives. SPE ANTEC 99 Abstracts, pp. 1298-1301, May 2-6, NY, N.Y.
12. Conner, A. H., et al., 1989. Soybean-based wood adhesives. In: Johnson, L. A., ed. New technologies for value-added products from proteins and Co-products: Symposium Proc. Ames Iowa: Center for Crop Utilization Research. P. 15-28.
13. Dunn, L. B. Jr., et al., 1995. Wood Adhesives. Proc. Symposium on Wood Adhesives, Forest Products Society, Madison Wis.
14. Kuo, M. L., et al.,1998. Properties of wood/agricultural fiberboard bonded with soybean-based adhesives. Forest Products J. 48(2): 71-75.
15. Kuo, M. L., and Stokke, D. D., 2000. Soybean-based adhesive resins for composite products. In: Wood Adhesives 2000. Extended Abstracts. P. 32-33, June 22-23, South Lake Tahoe, Calif. Forest Products Soc. Madison, Wis.
16. Lambuth A., 1966. In Skeist, I. ed.: Handbook of Adhesives, Guinn Co, N.J.
17. Vijayendran, B. r, et al., 1998. Studies of the alkaline hydrolysis of soy protein and characterization of hydrolyzate products for potential application in wood adhesives. AOCA 89^{th} Annual Meeting Abstracts, 18, May 10-13, Chicago, Ill.: p. 18.
18. Wolfe, W. and Cowan, J. C., 1975. Soybeans as a food source, 1975, CRC Press, Cleveland.

1. A water-resistant thermosetting adhesive resin comprising a phenol-activated hydrolyzate of soy reacted with an aldehyde.

2. The resin of paragraph 1, wherein the mass of soy is from about 5% to about 75% of the total mass of soy and phenol of said adhesive resin.

3. The resin of paragraph 1, wherein said soy is at least about 30% of the total mass of the soy and phenol.

4. The resin of paragraph 1, wherein said soy is at least about 50% of the total mass of the soy and phenol.

5. The resin of paragraph 1, wherein the starting materials comprise at least about 20% soy.

6. The resin of paragraph 1, wherein the ratio of soy to phenol is from about 1:6 to about 1:1.

7. The resin of paragraph 1, wherein the resin comprises from about 5% to about 25% soy, from about 15% to about 50% phenol, and from about 10% to about 50% aldehyde.

8. The resin of paragraph 7, further comprising about 4% to about 25% alkali.

9. The resin of paragraph 7, further comprising about 0.4% to about 10.0% acid.

10. The resin of paragraph 1, wherein the solid content is from about 40% to about 60%.

11. The resin of paragraph 1, wherein the viscosity is from about 100 cps to about 10,000 cps.

12. The resin of paragraph 1, wherein the pH is from about 9 to 13.

13. A process for making a thermosetting adhesive resin, comprising
(a) hydrolyzing a soy product in the presence of water, a phenol, and an alkali, to form a reactive hydrolyzate, and
(b) combining the hydrolyzate with an aldehyde and producing a phenol-substituted aldehyde thermosetting adhesive resin.

14. A process according to paragraph 13, further comprising combining additional components selected from the group consisting of extenders, fillers, and water to the final resin product.

15. A process according to paragraph 13, wherein the hydrolyzing step comprises combining soy with a phenol, water, and an aqueous strong alkali, and stirring and heating the hydrolyzate mixture at about 50 to about 150 degrees Celsius for at least about 10 minutes to produce the reactive hydrolyzate.

16. A process according to paragraph 13, wherein the converting step comprises combining aldehyde, phenol and alkali with the hydrolyzate to form a resin mixture and heating the resin mixture at about 50 to about 120 degrees Celsius for at least about 30 minutes to produce the resin.

17. A process as in paragraph 13, wherein the soy product is selected from the group consisting of soybean, soy flour and soy meal.

18. A process as in paragraph 13, wherein the resin comprises from about 5% to about 30% of soy by weight.

19. A process as in paragraph 13, wherein the phenol is selected from the group consisting of phenol, cresol, xylol, resorcinol and combinations.

20. A process for making a hydrolyzate of soy useful for producing a thermosetting adhesive resin, comprising hydrolyzing soy in the presence of water, a phenol, and an alkali, to form a hydrolyzate, without an adelhyde.
